(19) United States
(12) Patent Application Publication
(10) Pub. No.: US 2025/0341071 A1
(43) Pub. Date: Nov. 6, 2025

(54) EQUIPMENT CAPABLE OF CLEANING UP TOXIC BLUE-GREEN ALGAE FROM BODIES OF WATER FROM THE SIDES OF VESSELS

(71) Applicant: Robert Marshall Campbell, Miami, FL (US)

(72) Inventor: Robert Marshall Campbell, Miami, FL (US)

(21) Appl. No.: 19/266,822

(22) Filed: Jul. 11, 2025

Related U.S. Application Data
(63) Continuation-in-part of application No. 18/128,138, filed on Mar. 29, 2023.
Application No. 18/128,138 is a continuation-in-part of application No. 17/707,858, filed on Mar. 29, 2022, now Pat. No. 12,263,922.
(60) Provisional application No. 63/167,615, filed on Mar. 29, 2021.

(51) Int. Cl. E02B 15/10; B01D 33/056; B63B 35/32; C02F 1/00; C02F 103/00; E02B 15/08

(52) U.S. Cl. CPC E02B 15/10; B01D 33/056; B63B 35/32; C02F 1/004; E02B 15/08; C02F 2103/007

(57) ABSTRACT

Cleanup and recovery equipment for removing a biological contaminant from a body of water, and a vessel containing same, the equipment including an intake end, a second end, two vertical walls, and a filtering material extending between the vertical walls and having outer side portions of the that press against and create a seal with lower inner surface portions of the two vertical walls and extending from the intake end to the second end such. When activated on a forward-moving vessel, the filtering material separates the biological contaminant from the body of water as water and biological contaminant from the body of water is forced upward and between the two vertical walls and over the filtering material, using water pressure resulting from the motion of the vessel and the weight of the upwardly forced water. The filtering material transports the biological contaminant toward the second end.

### CROSS-REFERENCE TO RELATED APPLICATIONS

This application is a continuation-in-part of U.S. patent application Ser. No. 18/128,138, filed Mar. 29, 2023, which is a continuation-in-part of U.S. patent application Ser. No. 17/707,858, filed Mar. 29, 2022, which claims the benefit of U.S. Provisional Application No. 63/167,615 filed Mar. 29, 2021, the disclosure of which is hereby incorporated herein by reference in its entirety.

### FIELD AND BACKGROUND OF THE INVENTION

This invention relates to the field of floating contaminant cleanup and recovery equipment and vessels, capable of cleaning up of cyanobacteria, or what is commonly referred to as toxic blue green algae and other biological contaminants, from inland waterways, lakes and other fresh bodies of water. As well as for the effective cleanup of red tide, when in full bloom out at sea and along coastlines.

### SUMMARY

The following presents a simplified summary of the disclosure in order to provide a basic understanding of some aspects of the various embodiments disclosed herein. This summary is not an extensive overview of every detail of every embodiment. It is intended to neither identify key or critical elements of every embodiment nor delineate the scope of every disclosed embodiment. Its sole purpose is to present some concepts of disclosure in a simplified form as a prelude to the more detailed description that is presented later.

In an embodiment, a vessel for cleaning contaminant floating on a body of water may include a hull having two long sides, a containment tank, a first cleanup and recovery equipment, and a first containment boom. The first cleanup and recovery equipment may include an intake end, a second end, and a filtering material extending there between, such that the first cleanup and recovery equipment may be capable of being deployed on one of the two long sides of the hull such that the intake end is disposed within the body. When activated, the first cleanup and recovery equipment may collect the contaminant floating in the body of water onto the filtering material and transports same towards the second end to facilitate depositing the contaminant in the containment tank. The first containment boom may capable of being deployed from near the intake end of the first cleanup and recovery equipment, such that when the vessel is traveling in a direction on the body of water and has deployed the first cleanup and recovery equipment and the first containment boom, the first containment boom captures and funnels the contaminant towards the intake end of the first cleanup and recovery equipment.

In an embodiment, a contaminant cleanup and recovery equipment for removing of toxic blue green algae from a body of water may include an intake end, a second end, and a filtering material extending therebetween. The cleanup and recovery equipment may be capable of being deployed on one of two long sides of a hull of a vessel such that the intake end is disposed within the body of water such that when activated, the cleanup and recovery equipment may collect the contaminant floating in the body of water onto the filtering material, and transports same towards the second end, facilitate depositing the contaminant in a containment tank.

In an embodiment, a vessel for cleaning toxic blue-green algae floating on a body of water may include a hull having two long sides and a first cleanup and recovery equipment having an intake end, a second end, two vertical walls and a filtering material extending between the vertical walls. The outer side portions of the filtering material may press against and create a seal with a lower inner surface portion of the two vertical walls. The filtering material may also extend from the intake end to the second end of the first cleanup and recovery equipment such that when activated while the vessel is moving forward, the filtering material separates the toxic blue-green algae from the body of water as water and toxic blue-green algae from the body of water is forced upward and between the two vertical walls and over the filtering material using a water pressure resulting from the motion of the vessel and the upwardly forced water, and transports the toxic blue-green algae toward the second end of the first cleanup and recovery equipment and into the vessel.

In an embodiment, a contaminant cleanup and recovery equipment for removing of toxic blue-green algae from a body of water may include an intake end, a second end, two vertical walls, and a filtering material extending between the vertical walls. Outer side portions of the filtering material may press against and create a seal with a lower inner surface portion of the two vertical walls. The filtering material may also extends from the intake end to the second end of the first cleanup and recovery equipment such that when activated while the vessel is moving forward, the filtering material separates the toxic blue-green algae from the body of water as water and toxic blue-green algae from the body of water is forced upward and between the two vertical walls and over the filtering material using a water pressure resulting from the motion of the vessel and the upwardly forced water, and transports the toxic blue-green algae toward the second end of the first cleanup and recovery equipment and into the vessel.

In an embodiment, a floating biological contaminant cleanup and recovery equipment mountable on an outer freeboard portions of a vessel on a body of water containing a biological contaminant, may include a forward intake end capable of being disposed within the body of water, a second end capable of being disposed above the forward intake end, a filtering material extending there between capable of allowing water to from the body of water to freely pass through the filtering material while restricting biological contaminants from passing through, and a first and second vertical wall extending vertically upward, and comprising lower inner surface portions. The filtering material may include outer side portions that may create a slidable seal against the lower inner surface portions of the first and second vertical walls, creating a containment area there-between, such that when activated while the vessel is moving forward, the filtering material separates the biological contaminant from the body of water as water and biological contaminant from the body of water is forced upward and between the first and second vertical walls and over the filtering material using a water pressure resulting from the motion of the vessel and the upwardly forced water, and transports the biological contaminant toward the second end.

### BRIEF DESCRIPTION

The drawings set forth exemplary embodiments of the disclosed concepts and are not intended to be limiting in any way.

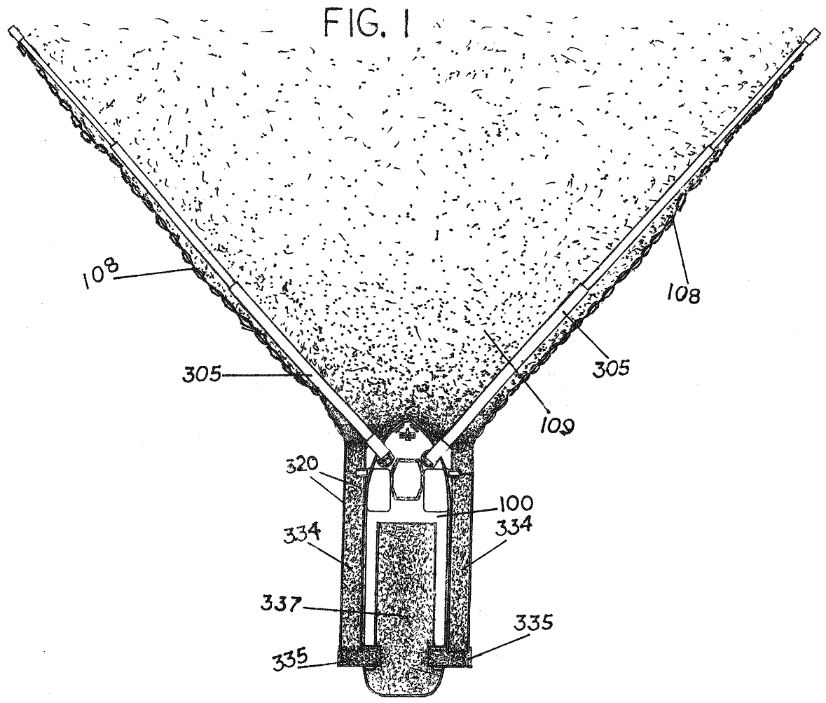

FIG. 1 illustrates an overhead view of an embodiment of the contaminant cleanup equipment mounted on both of the outer side portions of a vessel, that is also equipped with an extendable and angularly adjustable armatures or telescopic cranes maintaining the outer end portions of lengths of containment booms out in front of and of to each side on the vessel and cleaning up contaminant from a body of water.

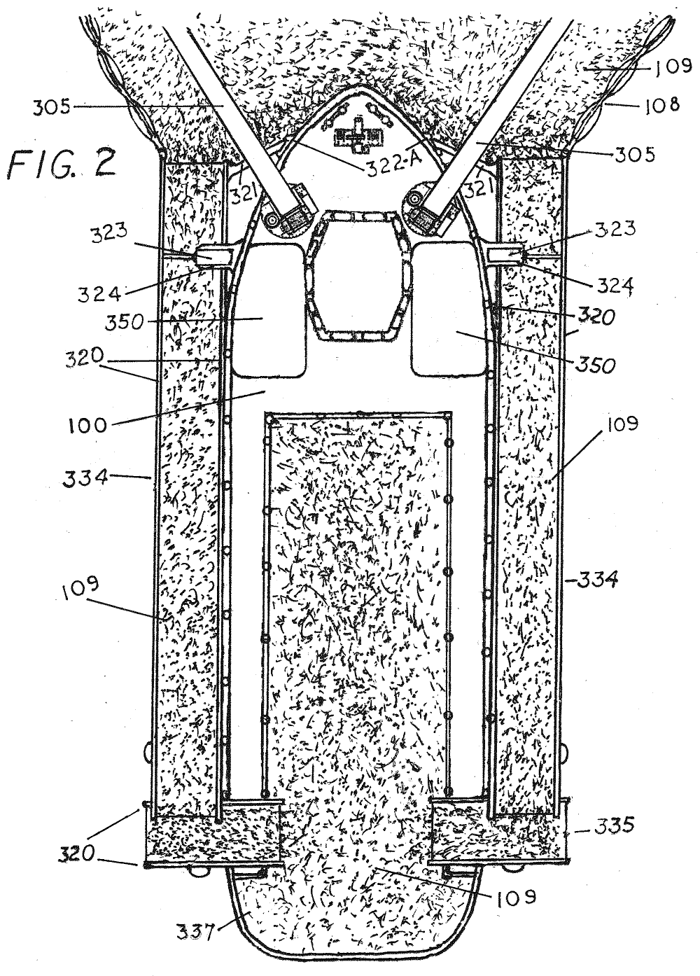

FIG. 2 illustrates a closer overhead view of the same embodiment of FIG. 1 with the contaminant cleanup equipment mounted on both of the outer side portions of a vessel.

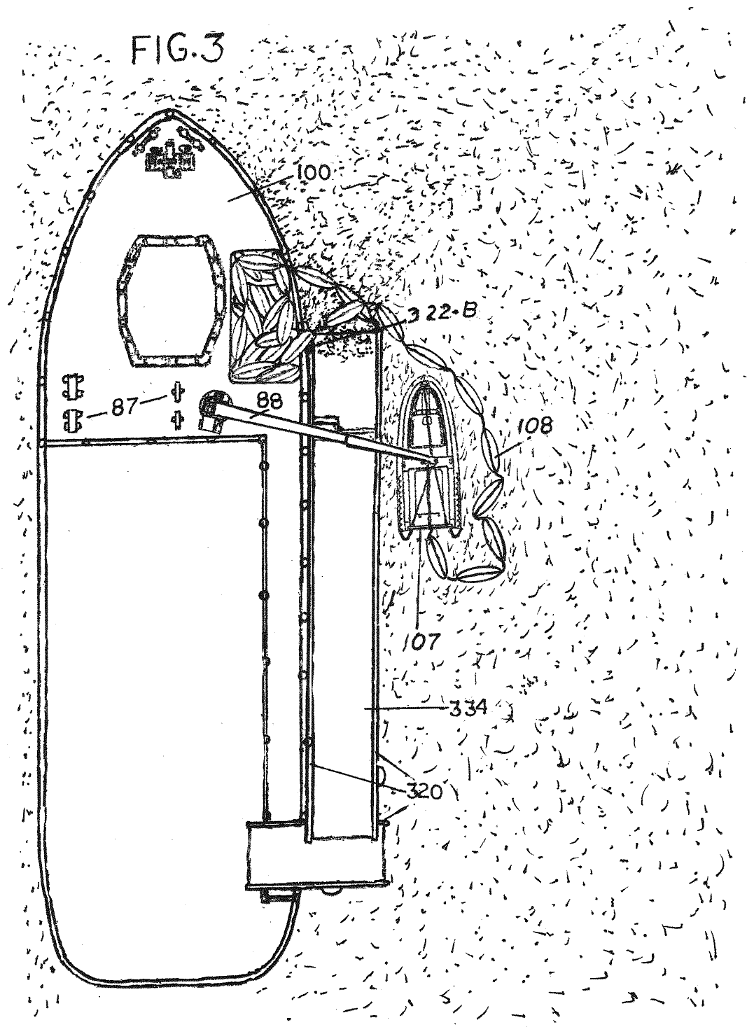

FIG. 3 illustrates an overhead view of an embodiment of a monohull type vessel, equipped with a contaminant cleanup equipment stationed on an outer side portion of only one side of a vessel and employing a towing vessel that is being launched into the water by means of a hydraulic lift, in order to deploy a length of contaminant containment boom out in front of and of to only one side of the vessel, to funnel, channel and concentrate the contaminants back to the cleanup equipment, stationed on same.

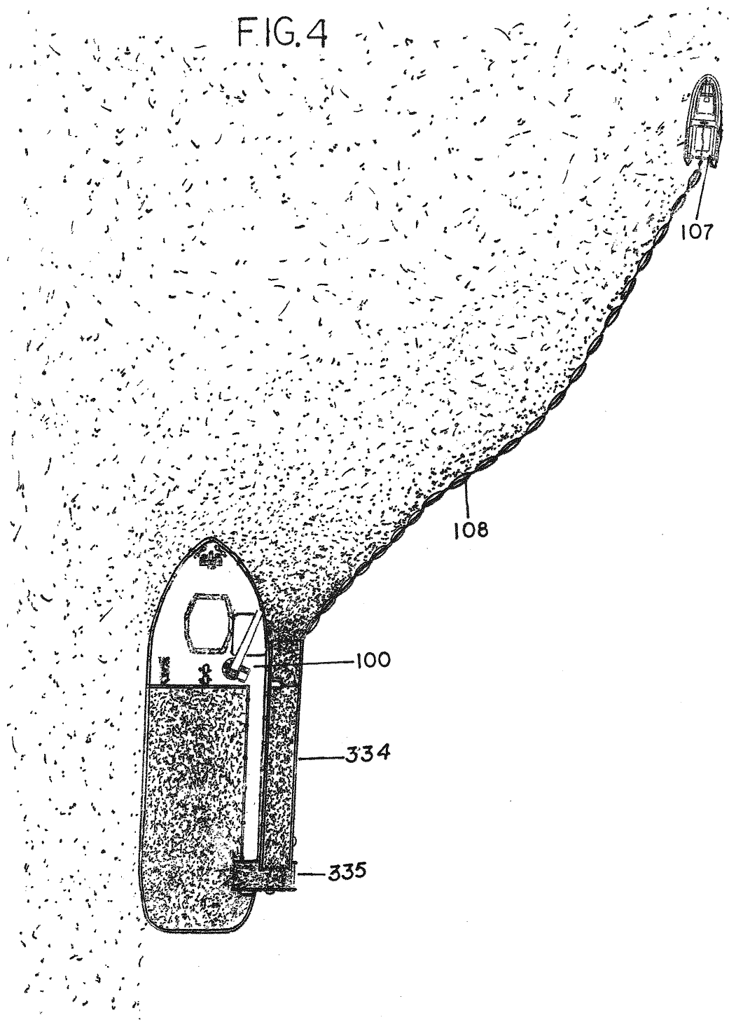

FIG. 4 illustrates an overhead view of the same embodiment a monohull type vessel of FIG. 3, with the tow boat and containment boom fully deployed such that the tow vessel maintains the length of contaminant containment boom out in front of and off to the starboard side of the vessel.

FIG. 5-A. illustrates a side or profile view of an embodiment of a monohulled type vessel, equipped with floating contaminant cleanup and recovery equipment deployed on a side of the vessel, with the forward intake end portion thereof lowered into a position below the waterline of the vessel. This drawing is also drawn that is drawn as if the outer contaminant containment panel portion of same (not shown was removed) to view an embodiment of the components comprising of the cleanup and recovery equipment.

FIG. 5-B. Illustrates a side or profile view of the same monohulled type vessel, equipped with the same embodiment of the floating contaminant cleanup equipment stationed on the same side of the vessel, as is included in FIG. 5-A. With this drawing including the forward intake end portion of the equipment raised out of the water into a position of non service above the waterline of the vessel.

FIG. 6 illustrates an overhead view of an embodiment of a large portion of the floating contaminant cleanup and recovery equipment. Of FIGS. 1 and 2.

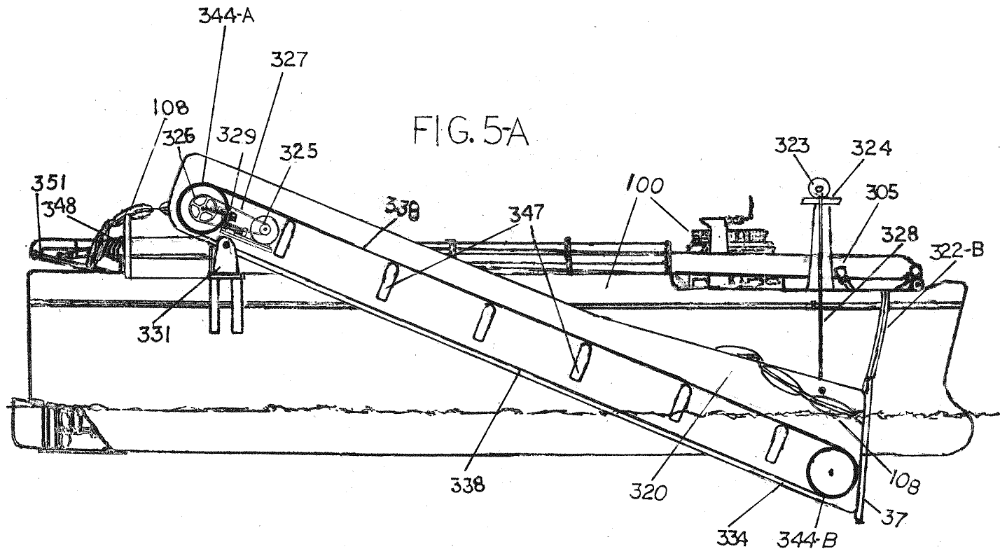

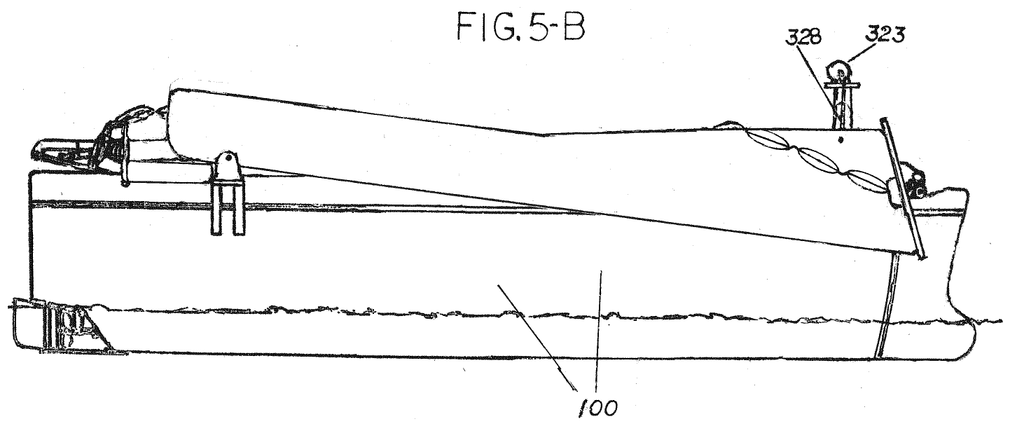

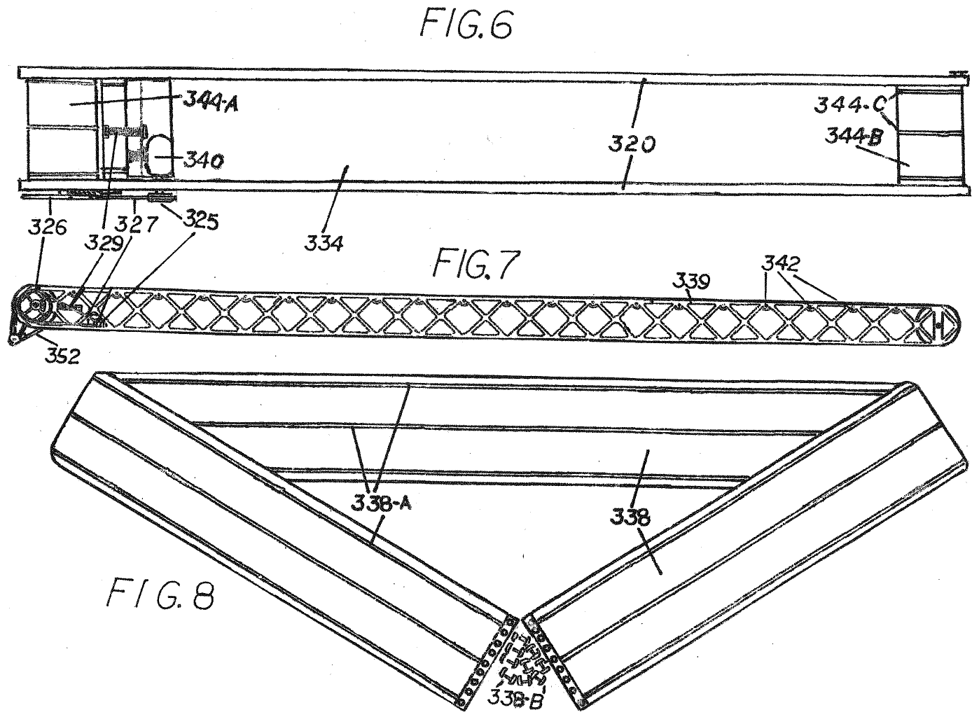

FIG. 7 illustrates a side, or profile view of the embodiment of the floating contaminant cleanup equipment of FIG. 6. With the rigid vertical panels removed from the outer side portions of same.

FIG. 8 illustrates an embodiment of a filtering material portion of the floating contaminant cleanup equipment, capable of allowing water to freely pass through same, while restricting contaminants from passing through same.

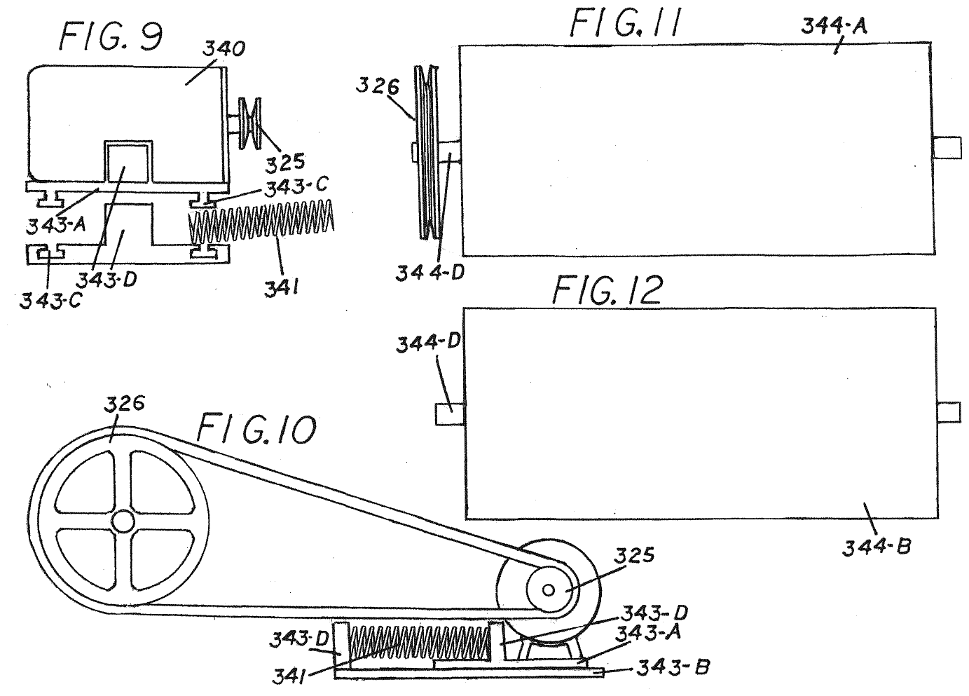

FIG. 9 illustrates a dissembled forward view of an embodiment of a drive motor and drive motor mount for the floating contaminant cleanup equipment of FIG. 6, and FIG. 7.

FIG. 10 illustrates an assembled side or profile view of the same embodiment of a drive motor, motor mount, belt and pulley for a main drive roller portions of the floating contaminant cleanup equipment of FIG. 6, and FIG. 7.

FIG. 11 illustrates a top view of the main drive roller and pulley of FIG. 6, and FIG. 7

FIG. 12 illustrates a top view of a roller of the floating contaminant cleanup and recovery equipment of FIG. 6, and FIG. 7.

### DETAILED DESCRIPTION

The following detailed description and the appended drawings describe and illustrate exemplary embodiments solely for the purpose of enabling one of ordinary skill in the relevant art to make and use the invention. As such, the detailed description and illustration of these embodiments are purely exemplary in nature and are in no way intended to limit the scope of the invention, or its protection, in any manner. It should also be understood that the drawings are not to scale and in certain instances details have been omitted, which are not necessary for an understanding of the present invention, such as conventional details of fabrication and assembly.

In an embodiment, a vessel for cleaning toxic blue-green algae floating on a body of water may include a hull having two long sides and a first cleanup and recovery equipment having an intake end, a second end, two vertical walls and a filtering material extending between the vertical walls. The outer side portions of the filtering material may press against and create a seal with a lower inner surface portion of the two vertical walls. The filtering material may also extend from the intake end to the second end of the first cleanup and recovery equipment such that when activated while the vessel is moving forward, the filtering material separates the toxic blue-green algae from the body of water as water and toxic blue-green algae from the body of water is forced upward and between the two vertical walls and over the filtering material using a water pressure resulting from the motion of the vessel and the upwardly forced water, and transports the toxic blue-green algae toward the second end of the first cleanup and recovery equipment and into the vessel.

In certain embodiments, the vessel for cleaning toxic blue-green algae floating on a body of water may further include a first containment boom capable of being deployed from near the intake end of the first cleanup and recovery equipment, and extending forward and off to a first side of the vessel, such that when the vessel is moving forward on the body of water and has deployed the first cleanup and recovery equipment and the first containment boom, the first containment boom captures and funnels the contaminant toward the intake end of the first cleanup and recovery equipment. In certain embodiments, the vessel for cleaning toxic blue-green algae floating on a body of water may further include a second cleanup and recovery equipment comprising an intake end, a second end, two vertical walls and a filtering material extending between the vertical walls. The outer side portions of the filtering material of the second cleanup and recovery equipment may press against and create a seal with a lower inner surface portion of the two vertical walls of the second cleanup and recovery equipment. The filtering material of the second cleanup and recovery equipment may also extends from the intake end to the second end of the of the second cleanup and recovery equipment such that when activated while the vessel is moving forward, the filtering material of the second cleanup and recovery equipment separates the toxic blue-green algae from the body of water as water and toxic blue-green algae from the body of water is forced upward and between the two vertical walls and over the filtering material of the second cleanup and recovery equipment using a water pressure resulting from the motion of the vessel and the upwardly forced water, and transports the toxic blue-green algae toward the second end of the second cleanup and recovery equipment and into the vessel. In certain such embodiments, the vessel for cleaning toxic blue-green algae floating on a body of water may further include a second containment boom capable of being deployed from near the intake end of the second cleanup and recovery equipment, and extending forward and off to a second side of the vessel such that when the vessel is moving forward on the body of water and has deployed the second cleanup and recovery equipment and the second containment boom, the second containment boom captures and funnels the contaminant toward the intake end of the second cleanup and recovery equipment.

In certain embodiments, the first cleanup and recovery equipment may further include a primary roller rotatable by a drive motor such that the primary roller can move the filtering material. In certain such embodiments, the primary motor may be slidably mounted on a mounting base. In certain embodiments, a first tow boat may connect to and tow the first containment boom. In certain embodiments, the vessel for cleaning toxic blue-green algae floating on a body of water may further include a boom capable of deploying and recovering the first tow boat.

In certain embodiments, the vessel for cleaning toxic blue-green algae floating on a body of water may further include a first deployment equipment capable of deploying the first cleanup and recovery equipment from a stored position to an operating position. In certain embodiments, the first deployment equipment may be a winch. In certain embodiments, the vessel for cleaning toxic blue-green algae floating on a body of water may further include a tank capable of storing the toxic blue-green algae removed from the body of water. In certain embodiments, the vessel for cleaning toxic blue-green algae floating on a body of water may include a first armature capable of deploying the first containment boom. In certain such embodiments, the first armature comprises a telescoping crane.

In an embodiment, a contaminant cleanup and recovery equipment for removing of toxic blue-green algae from a body of water may include an intake end, a second end, two vertical walls, and a filtering material extending between the vertical walls. Outer side portions of the filtering material may press against and create a seal with a lower inner surface portion of the two vertical walls. The filtering material may also extends from the intake end to the second end of the first cleanup and recovery equipment such that when activated while the vessel is moving forward, the filtering material separates the toxic blue-green algae from the body of water as water and toxic blue-green algae from the body of water is forced upward and between the two vertical walls and over the filtering material using a water pressure resulting from the motion of the vessel and the upwardly forced water, and transports the toxic blue-green algae toward the second end of the first cleanup and recovery equipment and into the vessel.

In certain embodiments, the contaminant cleanup and recovery equipment for removing of toxic blue-green algae from a body of water may further include a pivotable attachment capable of connecting to the hull of a vessel. In certain embodiments, the contaminant cleanup and recovery equipment for removing of toxic blue-green algae from a body of water may further include a first containment boom capable of being deployed from near the intake end of the first cleanup and recovery equipment, and extending forward and off to a first side of the first cleanup and recovery equipment such that when equipped and deployed on a vessel that is moving forward on the body of water the first containment boom captures and funnels the contaminant toward the intake end. In certain embodiments, the contaminant cleanup and recovery equipment for removing of toxic blue green algae from a body of water may further include a primary roller rotatable by a drive motor such that the primary roller can move the filtering material. In certain such embodiments, the primary motor may be slidably mounted on a mounting base.

In an embodiment, a floating biological contaminant cleanup and recovery equipment mountable on an outer freeboard portions of a vessel on a body of water containing a biological contaminant, may include a forward intake end capable of being disposed within the body of water, a second end capable of being disposed above the forward intake end, a filtering material extending there between capable of allowing water to from the body of water to freely pass through the filtering material while restricting biological contaminants from passing through, and a first and second vertical wall extending vertically upward, and comprising lower inner surface portions. The filtering material may include outer side portions that may create a slidable seal against the lower inner surface portions of the first and second vertical walls, creating a containment area there-between, such that when activated while the vessel is moving forward, the filtering material separates the biological contaminant from the body of water as water and biological contaminant from the body of water is forced upward and between the first and second vertical walls and over the filtering material using a water pressure resulting from the motion of the vessel and the upwardly forced water, and transports the biological contaminant toward the second end.

In certain embodiments, the biological contaminant may be toxic blue-green algae.

In an embodiment, a vessel for cleaning contaminant floating on a body of water may include a hull having two long sides, a containment tank, a first cleanup and recovery equipment, and a first containment boom. The first cleanup and recovery equipment may include an intake end, a second end, and a filtering material extending there between, such that the first cleanup and recovery equipment may be capable of being deployed on one of the two long sides of the hull such that the intake end is disposed within the body. When activated, the first cleanup and recovery equipment may collect the contaminant floating in the body of water onto the filtering material and transports same towards the second end to facilitate depositing the contaminant in the containment tank. The first containment boom may capable of being deployed from near the intake end of the first cleanup and recovery equipment, such that when the vessel is traveling in a direction on the body of water and has deployed the first cleanup and recovery equipment and the first containment boom, the first containment boom captures and funnels the contaminant towards the intake end of the first cleanup and recovery equipment.

In certain embodiments, a first tow boat may connect to and tow the first containment boom at an angle relative to the direction of travel of the vessel. In certain embodiments, the vessel may further include a boom capable of recovering and deploying the first tow boat. In certain embodiments the first cleanup and recovery equipment may include a first vertical containment wall disposed on a side of the filtering material. In certain embodiments, the first cleanup and recovery equipment may include a second vertical containment wall disposed on an opposite side of the filtering material.

In certain embodiments, the vessel may include first armature capable of deploying the at least one containment boom. In certain embodiments, the first armature may include a telescoping crane. In certain embodiments the vessel may further include deployment equipment capable of moving the equipment from a stored position to an operating position. In certain embodiments, the deployment equipment may include a winch. In certain embodiments, the first cleanup and recovery equipment further may include a primary roller rotatable by a drive motor such that the primary roller can move the filtering material. In certain embodiments, the primary motor may be slidably mounted on a mounting base.

In certain embodiments, the filtering material may be provided with a guideline that engages a groove in the primary roller. In certain embodiments, the filtering material may be made from a single length of material having a first end and second end, wherein the first end and second end are connected to each other by at least one fastener. In certain embodiments, biological contaminants may be restricted from passing through the filtering material while water from the body of water is capable of passing through same as the captured biological contaminants are transported on the filtering material towards the containment tank. In certain embodiments, the biological contaminants may include toxic blue green algae.

Certain embodiments may further include a second cleanup and recovery equipment comprising an intake end, a second end, and a filtering material extending there between, the second cleanup and recovery equipment being capable of being deployed on another of the two long sides of the hull such that the intake end of the second cleanup and recovery equipment is disposed within the body of water. When the second cleanup and recovery equipment is activated, it may collect the contaminant floating in the body of water onto the filtering material of the second cleanup and recovery equipment and transports same towards the second end of the second cleanup and recovery equipment to facilitate depositing the contaminant in the containment tank. The vessel may further include a second containment boom capable of being deployed from near the intake end of the second cleanup and recovery equipment, such that when the vessel is traveling in a direction on the body of water and has deployed the second cleanup and recovery equipment and the second containment boom, the second containment boom captures and funnels the contaminant towards the intake end of the second cleanup and recovery equipment.

In an embodiment, a contaminant cleanup and recovery equipment for removing of toxic blue green algae from a body of water may include an intake end, a second end, and a filtering material extending therebetween. The cleanup and recovery equipment may be capable of being deployed on one of two long sides of a hull of a vessel such that the intake end is disposed within the body of water such that when activated, the cleanup and recovery equipment may collect the contaminant floating in the body of water onto the filtering material, and transports same towards the second end, facilitate depositing the contaminant in a containment tank.

In certain embodiments, the filtering material may be capable of restricting toxic blue green algae from passing through the filtering material while allowing water to pass through same. In certain embodiments the contaminant cleanup equipment may further include at least one vertical containment wall capable maintaining the biological contaminants and water being removed from same over the upper surface of the filtering material during the operation. In certain embodiments, the contaminant cleanup and recovery equipment may possess a pivotable attachment to the hull of the vessel.

FIG. 1 illustrates an on overhead view of a vessel #100 and An embodiment of floating contaminant cleanup and recovery equipment that possesses the ability to cleanup biological contaminants 109, such as cyanobacteria or toxic blue green algae, from a body of water and to do so at profound rates of recovery and levels of efficiency. But embodiments of the equipment included in this application, is the only type of equipment ever devised, that has proven capable of cleaning up toxic blue green algae from a body of water, at all!

Not only possesses the ability to remove toxic blue green algae or other biological contaminants from the surface of a body of water, but also from adjusted depths below the surface of a body of water as well, while doing so. Of which is an absolutely essential ability possessed by embodiments of this equipment. In that, not only do toxic blue green algae blooms include only a very thin outer surface portion thereof that's actually floating on the surface of the water but they can extend as much as six and even eight inches below the surface of the water as well. Of which nothing previously devised has ever been capable of cleaning up at all.

Embodiments of this equipment are effectively employable, either on one or on both sides of a monohull type vessel. However, this drawing includes a monohull vessel equipped with an embodiment of the floating contaminant cleanup and recovery equipment stationed and employed both on the port as well as the starboard outer side portions of a monohull type vessel. This embodiment of the vessel is also equipped with an embodiment of two extendable and angularly position-able armatures, or telescopic type cranes. #305. Mounted on each side of a forward portion of the vessel. (Of which were also included in and described in detail and employed in the same basic manner on vessels included in the last patent application, submitted by the applicant.) Of which were also equipped with an embodiment of a vertical rod or track as well as an end panel portion of a length of contaminant containment booms. #108. Slide-ably attached to each and extended outward thereon where same are maintained in positions in front of and off to each side of this embodiment of a monohull type of a contaminant cleanup and recovery vessel along with the opposite end portions of contaminant containment booms. #108. Attached to the outer intake portions of this variation of the floating contaminant cleanup and recovery equipment, stationed on the outer side portions of this embodiment of a monohull type vessel equipped with same.

The vessel #100 may include cleanup and recovery equipment #334, delivery equipment #335, a containment tank #337 armatures #305 and containment booms #108. The cleanup and recovery equipment #334 may be deployed off of the starboard or port sides of the vessel #100, or off of both. The cleanup and recovery equipment #334. May include a conveyor, or any other suitable equipment known, or to be discovered, having an intake end and a second end to extract the contaminant #109. from the body of water and transport it towards the containment tank #337. of the vessel #100. The cleanup and recovery equipment may further include

vertical containment walls. #320. To keep the contaminant #109 on the upper surface portions of the equipment and prevent it from falling off of the sides of same as the water is being filtered out of the captured contaminants, during the operation. The delivery equipment #335 may comprise a conveyor, a slide, a funnel, or any other suitable equipment known in the art or to be developed. The delivery equipment #335 may facilitate transportation of the recovered contaminant #109 to the containment tank #337, by receiving same and transporting it all or part of the way to the containment tank. The delivery equipment #335 may also be provided with vertical containment walls #320 to prevent the contaminant from spilling off of the sides of the equipment. Additional equipment, to help transport the contaminant or sensors to analyze and evaluate the contaminant as it is being collected may also be employed within the scope of the disclosed concepts.

The armatures and/or telescopic cranes #305 may include equipment to facilitate the deployment of the containment booms #108. For example, the armatures/cranes #305 may be disposed on a rotating platform that can be adjusted to set a desired collection angle. They may be provided with a motor, tracks, pulleys and/or other suitable structures or equipment known or to be developed that can facilitate deploying the containment booms #108. To deploy the containment booms #108, a selected length of boom #108 having a first end and a second end may be attached to the armature/crane #305, on one end and to an outside portion of the cleanup and recovery equipment #334 on the other end. The armature or crane #305 may then use its deployment equipment to pull the end of the containment boom #108 from its attachment point on or near the vessel, to near the distal end, or any other desired distance for collection of contaminant #109 such that the containment boom #108 can be extended and function to trap the contaminant and channel, funnel or otherwise guide the contaminant #109 towards the intake end of the cleanup equipment #334.

This drawing illustrates a monohull vessel #100 having a containment tank #337. The vessel #100. May be equipped with a floating contaminant cleanup and recovery equipment #334 and delivery equipment #335 deployed and employed both on the port as well as the starboard outer side portions of a monohull type vessel #100. To extract contaminant from the water and deliver it to the containment tank #337.

This embodiment of a floating contaminant cleanup vessel #100. May also be equipped with one or two extendable and angularly position-able armatures, or telescopic type cranes #305. Mounted on a portion of the vessel #100. The armatures or cranes may be equipped with an embodiment of a vertical rod or track as well as an end panel portion of a length of contaminant containment booms #108 that may be slide-ably attached to each armature or crane #305. When the armature or crane #305 is extended outward and maintained in positions in front of and off to each side of this the vessel #100 to deploy contaminant containment booms #108. The contaminant containment boom may be attached to the outer intake portions of this variation of the floating contaminant cleanup and recovery equipment #335 and to the ends of the armatures or telescoping cranes #305, stationed on the outer side portions of this embodiment of the vessel.

Embodiments of #334. and #335. May include both a lower rollers, stationed on the first ends thereof and upper rollers, stationed on the second end portions of each (Not viewable in this drawing of an embodiment thereof). However, embodiments of #334. and #335. May also include an embodiment of an electrical or hydraulic drive motor, capable of rotating at least one of the roller portions of each. Embodiments of these rollers are stationed laterally, both between the upper and the lower end portions of an embodiment of two rigid vertical containment panel. #320. Portions of this embodiment of the equipment. #334. and #335. Of which also comprise a reinforced filtering material. (Of which is not actually viewable in this drawing of an embodiment thereof.) However, this embodiment thereof, would extend laterally between the inside surface portions of the two vertical containment walls. #320. And extend lineally, in a contentious loop around the outer surface portions of the upper and lower rollers, (Also not viewable in this drawing of an embodiment of the equipment) However embodiments of these rollers may be stationed on both end portions of. #334. and #335. Between the inner and outer ridged containment walls. #320. Portions of this embodiment of the equipment.

However, an embodiment of this filtering material is actually supporting and transporting the captured toxic blue green algae #109. Included in this drawing, on the upper surface portions of same. Of which also allows the water to freely pass through embodiments of the filtering material portions of the equipment while restricting the toxic blue green algae or other biological contaminants from passing through same, during the operation.

Such that, during the operation and as a result of the head currents created as a result of forward motion of the vessel and the two lengths of contaminant booms being maintained out in front of and off to each side of the vessel by means of the two telescopic cranes #305. Included in this drawing of an embodiment thereof. And with the opposite end portions of the two lengths of contaminant booms extended back from the outer end portions of #305. And attached to the forward, outer intake portions of this embodiment of the equipment, stationed on the outer side portions of the vessel employing same. Not only are the contaminants #109 contentiously being gathered, channeled and concentrated all of the way back between the two lengths of the contaminant containment booms, #108. Extended out and of to each side of the vessel, by means of the head currents created as a result of the forward motion of the vessel and the embodiment of the equipment employed on same. But as soon as the toxic blue green algae or other biological contaminants. #109. Reaches the submerged lower intake end portions of the primary portions of this embodiment of the equipment. #334.

The contaminants, are also. Not only forced up between the two opposing vertical contaminant containment walls #320. Over the summered upper surface portions, of the filtering material. #338. portions, of this embodiment of the primary #334. Portions of the equipment. But as a result of the same head currents created as a result of the forward motion of the vessel and the water pressure created between the two vertical contaminant wall #320. Portions of the equipment. The contaminants are also firmly forced and maintained on the upper surface of the filtering material portions of this embodiment of the equipment as the water is forced through same, during the operation as well as a result of the additional water pressure created as a result of the water and contaminants rising up between the two vertical contaminant panel portions of the equipment over the moving filtering material portions of same, any water, inadvertently captured along with the toxic blue green algae, or other biological contaminants, during the operation, also drains through the filtering material portions of #334. and #335. And back into the body of water as the captured contaminants are being transported on the upper, outer surface portions of the filtering material portions, of this embodiment of both the primary #334. and deposited onto the upper surface portions of. #335. Of which continues to transport the captured contaminants off of the end portion of #335. And thus deposits same into the contaminant storage compartment or tank. #337. portion, or portions, of this embodiment of a monohull type of floating contaminant cleanup and recovery vessel. In this embodiment thereof.

FIG. 2 illustrates a closer overhead view of the same embodiment of a monohull type of a contaminant cleanup and recovery vessel, equipped with the same embodiment of the contaminant cleanup and recovery equipment. As is included in FIG. 1, with the contaminant cleanup equipment #334 mounted on both of the outer side portions of a vessel #100. This drawing was simply added, to better view and provide a description

of embodiments of some of the components not easily viewed in FIG. 1. Such as the vessel #100 may include deployment equipment, such as an electric or hydraulic winch #323 mounted on a platform #324. The hydraulic winch may lower the cleanup and recovery equipment from a stored position into an adjusted operating position with the forward intake portion of #334 positioned below the waterline of the vessel and the toxic blue green algae or other biological contaminants being cleaned up, during the operation. As well as to raise same up and into a position of transport or non use. Other types of deployment equipment known in the art or to be developed may be used with the disclosed concepts, including but not limited to, a crane which can lift the storage equipment and facilitate its placement in an operating position, an elevator framework which can lift and/or lower the equipment to move it into or out of an operating position, a compartment in the hull wall that can open and deploy the equipment, and/or any other suitable solution to deploying such equipment. The cleanup and recovery equipment #334 may further include the forward most end portions, of this embodiment of the main portions of the cleanup and recovery equipment #334, May also be equipped with or be slideably attached to an embodiment of an additional vertical panel #321. Connected to a forward portion of the hull of the vessel #100, or made as an integral portion of each of the inner end portions of this embodiment of the vertical contaminant containment wall #320 portions of #334. Of which this embodiment hereof may extend out laterally therefrom over to an embodiment of a type of vertical tracks, stationed on the stem, or other forward freeboard portions of each side of the vessel and extend below the waterline of same and extend vertically at a slight radius therefrom to a positions closely relative to, or higher than the main deck of the vessel. The Inner and, or the outermost portions of this embodiment of these tracks as well as the Inner and, or the outermost vertical end portions of this embodiment of each of the additional vertical panels #321. In this embodiment thereof. Would also be configured in a manner that, would not only provide the outer edge portions of the vertical panels #321. to be slide-ably connected to this embodiment of the primary portions of the equipment #334, the hull of the vessel hull #100. But would also provide a seal between both while doing so. In this drawing of an example of an embodiment thereof.

As well as to help funnel, channel and direct contaminant #109 floating on the body of water towards the intake end portions of the cleanup and recovery equipment #334. In this drawing of an embodiment thereof. The hull of the vessel or the inner vertical wall #320 of #334, may also be provided with vertical tracks, #322-A to facilitate vertical travel of the interior vertical containment panels #321. or the end portions of #334. The vessel #100 may further be provided with a containment boom storage #compartment #350, to store the containment booms #108, when the vessel is not operating to cleanup toxic blue green algae or other biological contaminants #109 from the body of water. These storage compartments may be provided with structural frameworks and equipment to facilitate storage of the containment booms in an efficient and easy-to-deploy manner. Such equipment may include automatic doors, and containment boom #109 folding and/or guiding tracks or machinery to facilitate collection and deployment of the containment booms #109.

Embodiments of equipment #334 and #335 may include both a lower rollers, stationed on the first ends thereof and upper rollers, stationed on the second end portions of each (Not viewable in this drawing of an embodiment thereof). However, embodiments of equipment #334 and #335 may also include an embodiment of an electrical or hydraulic drive motor, capable of rotating at least one of the roller portions of each. Embodiments of these rollers may be stationed laterally, both between the upper and the lower end portions of an embodiment of two rigid vertical containment wall. #320. Portions of this embodiment of the equipment. #334. and #335. Of which also comprise a filtering material. (Of which is not actually viewable in this drawing of an embodiment thereof.) However, of which would extend laterally between the inside surface portions of the two vertical containment walls. #320. And extend lineally, in a contentious loop around the outer surface portions of the upper and lower rollers, (Also not viewable in this drawing of an embodiment of the equipment) However embodiments of these rollers would be stationed on both end portions of. #334. and #335. Between the inner and outer ridged containment walls. #320. Portions of this embodiment of the equipment.

However, an embodiment of this filtering material is actually supporting and transporting the captured toxic blue green algae. Included in this drawing, on the upper surface portions of same. Of which also allows the water to freely pass through embodiments of the filtering material portions of the equipment while restricting the toxic blue green algae or other biological contaminants #109, from passing through same, during the operation.

Such that, during the operation and as a result of the head currents created as a result of forward motion of the vessel and the two lengths of contaminant booms. #108, being maintained out in front of and off to each side of the vessel by means of the two armatures or telescopic cranes #305. Included in this drawing of an embodiment thereof. And with the opposite end portions of the two lengths of contaminant booms extended back from the outer end portions of #305. And attached to the forward, outer intake portions of this embodiment of the equipment, stationed on the outer side portions of the vessel employing same. Not only are the contaminants #109, contentiously being gathered, channeled and concentrated all of the way back between the two lengths of the contaminant containment booms, #108. Extended out and of to each side of the vessel. But as soon as the toxic blue green algae or other biological contaminants. #109. Reaches the submerged lower intake end portions of the primary. #334. Portions of this embodiment of the equipment. The water and contaminants are also forced upwards between the two vertical contaminant containment walls #320. As the water is also contentiously being forced through the moving filtering material portion of the equipment the toxic blue green algae is also forced onto the upper surface portions, of the filtering material. portions, of this embodiment of the primary #334. Portions of the equipment and firmly maintained thereon, as the water is forced through the filtering material, portion of the equipment and the continuous upward travel of same during the operation. Any water, inadvertently captured along with the toxic blue green algae, or other biological contaminants, during the operation, also drains through the filtering material portions of #334. and #335. And back into the body of water as the captured contaminants are being transported on the upper, outer surface portions of the filtering material portions, of this embodiment of both the primary #334. Portions as well as the secondary portions #335. Of this embodiment of the equipment. Of which continues to transport the captured contaminants off of the end portion of #335. And thus deposits same into the contaminant storage compartment or tank. #337. portion, or portions, of this embodiment of a monohull type of floating contaminant cleanup and recovery vessel. In this embodiment thereof.

FIG. 3, as well as FIG. 4, illustrate overhead views of an embodiment of a vessel in accordance with the disclosed concepts, having a crane #88 capable of deploying and recovering a tow boat #107 in addition to cleanup and recovery equipment #334, delivery equipment #335 and a containment tank #337. In this manner the tow boat may extend the containment boom #108 a greater distance than that than can be achieved by the armature or crane #305 of the embodiment in FIG. 1. The vessel #100 may further be provided with boat skids #87 to facilitate storage and securement of one or more tow boats on the vessel. The same principles may be applied to have a second tow boat on the other side, or on both sides of vessel #100. This tow boat solution may be used with the embodiment of FIGS. 1 & 2, wherein the armatures #305 may be used to deploy towboats. Alternatively, tow boats #107 that are external to and independent of the vessel #100 may be used to tow and position the containment boom #108 in accordance with the disclosed concepts.

As shown in the embodiment in FIGS. 3&4. The hull may be provided with a deployment track 322-B. Capable of providing a vertically slidable attachment for the forward end portion of cleanup and recovery equipment 334, that minimizes the distance between the hull and the intake end of the cleanup and recovery equipment 334. In this manner the need for an interior vertical panel stationed between end portions of #334 and the hull of the vessel #100, may be reduced or eliminated.

This embodiment of the vessel as well as the embodiment of the floating contaminant cleanup and recovery equipment stationed on only one side of the vessel shares the greatest portion the composition of components, features and attributes as common with the embodiments of the vessels and equipment. As is included in the drawings of the embodiments thereof included in FIG. 1 and FIG. 2. As well as the drawings thereof included in FIGS. 5-A. and FIG. 5-B. With the exception of several obvious differences. Both to the actual type of equipment employed on and by the vessel it self both to deploy and maintain the contaminant containment boom forward and off to the one side of the vessel actually being accomplished by means of a much smaller vessel, or vessels, employed as a contaminant containment towing boat or boats. #107, that would both be launched into the water by means of this embodiment of a hydraulic boom lift. #88. At the beginning of the operation, along with an end of the length of the contaminant containment boom #108 pre-attached to same and with the opposite end of #88. Pre-attached to the forward outer end portion of the outboard vertical panel portion of this embodiment of the equipment. And also simply re-stored back into the boat skids #87. for the contaminant containment towing boat #107. Stationed on the main deck of this embodiment of the vessel. Also by means of this embodiment of the same hydraulic boom lift. #88. in this embodiment thereof. The solitary primary portions of the contaminant cleanup equipment. #334. Included in this drawing of an embodiment thereof. Also possess a couple of differences to the drawings of the other embodiments thereof. Included in this application. The first of these differences being the position of forward interlocking slide and track #322-B. Portion of this embodiment of the equipment, with the slide portion thereof, stationed vertically, directly onto the forward most portion of the inner vertical contaminant contentment panel, portion of the equipment. Of which this embodiment thereof would be slid-ably interlocked into the track portion of same. Of which, this embodiment thereof, would also extend from a position below the waterline and extend vertically upward therefrom at a slight radius to a an upper end portion of same, closely relative to, or higher than the main deck of the vessel. However, this embodiment of a track #322-B. As well as the slide portion of same stationed on the outer surface, of the inner end portion, of the ridged containment wall #320, portion of #334, along with, this embodiment of the forward intake portion #334. Of this embodiment of the equipment, would be stationed at and extend forward, only to the after most radius of the bow portion of this embodiment of the vessel. Thus, even much further reducing the weather helm, created as a result of this embodiment of the contaminant cleanup equipment being stationed on only one side. Of this embodiment of the vessel.

The radical reduction in the weather helm, also being the primary reason in which this embodiment of the vessel, is also provided with a tow boat. #107. To tow the length of contaminant boom #108. between same and the outer intake portion of this embodiment of the contaminant cleanup equipment, stationed on only one side of the vessel. Of which would add very little additional drag and thus also very little additional weather helm to the embodiment of the vessel, equipped in this manner, to very easily manageable levels. In this embodiment thereof.

FIG. 4. Simply includes a drawing of an overhead view of the same embodiment a monohull type of a contaminant cleanup and recovery vessel, equipped with the same embodiment of the contaminant cleanup and recovery equipment. #334. and #335. Stationed only on a single side of the vessel. As is included in FIG. 3. With this drawing, drawn as if same was in full service, cleaning up and removing all of the toxic blue green algae from a body of water. With the tow boat #107. Maintaining the length of contaminant containment boom #108. Out in front of and off to the starboard side of this embodiment of the vessel. The only real advantages to equipping a vessel, with an embodiment of this equipment on only one side of a vessel, would be the actual overall cost of equipping the vessel. However, not only could an embodiment of the vessel, equipped in this manner, be capable of achieving only one half of the rate of recovery as other vessels equipped with embodiments of this equipment on both sides of the vessel, but the vessel would also haft to employ an extra crew member to run the tow boat as well. In this embodiment thereof.

FIG. 5-A. Illustrates a side or profile view of an embodiment of a monohulled type vessel, #100. Equipped with an embodiment of the floating contaminant cleanup and recovery equipment #334. Deployed on a side of the vessel, with the forward intake end portion thereof lowered into a position of employment, below the waterline of the vessel. And the deepest portions of the toxic blue green algae of other biological contaminants floating in the body of water. This drawing is also drawn as if the outer contaminant containment panel portion thereof #320. Had been removed or was transparent to provide a view the basic composition of components comprising this embodiment of the main portion of the contaminant cleanup and recovery equipment. #334. In accordance with the disclosed concepts. This drawing also includes the armatures or cranes #305. Yet to be deployed and still remaining in their stored positions, with the end portions thereof, facing the aft of the vessel #100. The main portion or portions of the cleanup and recovery equipment #334 may include a primary mounting bracket. #331, supporting an upper end of the equipment. And a pivotable attachment of #334, the vessel 100. #334. May further be provided with a drive motor #340 connected to a pulley or sprocket. #325, that may be further connected to a pulley or sprocket #326 on a primary roller #344-A, By a belt or chain. #327. An adjustment mechanism, such as threaded rod #329 may be provided to adjust the position of the primary roller #344-A to control the tension of the filtering material extending between and around the outer end portions of the upper #344-A. And lower roller #344-B, Stationed near the lower intake and the upper end portions of this embodiment of the equipment #334. And the filtering material portion of the equipment extending around the outermost portions and between #334-A and #334-B

An embodiment of the equipment may also include a plurality of additional rollers (not shown) in this drawing but may be disposed within the body of a frame work. Such as is included in FIG. 7. Or extending between the vertical wall portions #320 of #334 and #335. Of which may further be provided with a plurality of beams #347. As is included in this drawing of an embodiment of #334. Extending laterally between the inner portions of the inner and outer vertical contaminant wall. #320. portions of #334. and of which could provide embodiments of the cleanup and recovery equipment with higher levels of structural stability, While also providing additional support for the upper span of the filtering material and the captured contaminants being transported on the upper surface portions of same between the lower and upper roller #344-A and #344-B. Portions of this embodiment of #334.

As shown in FIG. 5-A and FIG. 5-B. A winch, such as a hydraulic or electric winch #323 may be disposed on platform 324. And employ a cable #328 connected to an end portion of #334. To raise or lower the intake end of the primary portion or portions of the equipment #334. Into the body of water and position it as needed via cable #328.

This drawing of an embodiment thereof, was also drawn the vessel #100. Had just arrived to clean up a body of water contaminated with toxic blue green algae and as if a crew member had just finished lowering the first primary portion of the equipment #334, into the water and had adjusted the end intake portion of same to a desired depth under the surface of the water, by means of an embodiment of winch #323. And cable #328. Stationed on a platform #324. positioned over a forward center portion of the equipment and with this embodiment of a cable attached both to upper forward portions of this embodiment of the inner and outer vertical contaminant containment panel #320. Portions of this embodiment of the equipment. Of which are drawn as if same were transparent to view a portion of the basic composition of components comprising this embodiment thereof.

With this embodiment of the vertical wall. #320, portions of the equipment attached to each other and maintained at equal distances apart from each, as well as maintained both laterally and vertically parallel relative to each other, by means of a plurality of beams #347. extending laterally between each other and welded to the inside surface portions of 320. In this embodiment thereof. An effective mode to complete the procedure of putting the rest of the equipment into operation would be either for the same, or another crew member to raise the extendable and angularly position-able armatures. #305. out of the out of the racks for same. And pull the lengths of contaminant booms #108. out of the storage bins for same, during the process. (Not viewable in this drawing. But included in the overhead view as well as the description of the same embodiment thereof. Included in FIG. 1. through FIG. 4.) Of which may also accomplished at the same time simply by means of the extending and positioning of this embodiment of the extendable and positionable armatures. #305. Or telescopic cranes, out in front of and of to at least one side of the vessel, along with the lengths of contaminant booms #108. attached to an embodiment of a vertical rod or track #351. Stationed on the end portions of each and include the opposite end portions of each length of the contaminant booms, also pre-attached to this embodiment of a vertical rod or track #37. Stationed on the outer end portions of this embodiment of each, of the outer main vertical contaminant containment wall #320. portions of this embodiment of the contaminant cleanup and recovery equipment. In this embodiment thereof.

FIG. 5-B. Illustrates a side or profile view of the same embodiment of a monohulled type vessel. #100. Equipped with the same embodiment of the floating contaminant cleanup equipment stationed on the same side of the vessel, as is included in FIG. 5-A. An embodiment of a primary mounting bracket. #331. for this embodiment of the primary portion of the equipment #334. Is stationed on and extends outward either from upper aft portions of the main deck, or outer upper side portions of this embodiment of vessel 100, and provide the primary portion or portions of the equipment #334 with a pivotable attachment to the upper aft portion or portions of vessel and thus, the angular adjustability of this embodiment of the primary portion, or portions of the equipment along with the adjustability of the height and depth of the forward intake end portions of same, relative to the surface of the water. on the sides of a vessel by means of the embodiments of winch. #323. stationed on the platform #324. And cable #328, portion of same connected to upper forward portions of the vertical contaminant containment panel portions #320. Of the equipment. In this embodiment thereof.

This drawing of the vessel and the contaminant cleanup equipment employed on same, includes the forward intake end of the primary portion of the floating contaminant cleanup equipment #334. Raised to a height out of the water to a position of non service above the waterline of the vessel, by means of a crew members employment of this embodiment of winch #323. As if this embodiment of the vessel and the floating contaminant cleanup equipment had just arrived or had just finished a contaminant cleanup operation and was in the process of deploying or in the process of raising #334 up and into a stored position of non use. In this embodiment thereof. FIG. 6. Illustrates an overhead view of an embodiment of a portion of the basic composition of components comprising an embodiment of a primary portion of the floating contaminant cleanup equipment. #334. Of which may include an upper drive roller stationed a second end portion of #334. And secondary roller #344-B. Stationed on a first or a lower end of #334. As discussed above, additional rollers may also be provided between the two vertical contaminant containment panel #320, portions of #334 as well to better facilitate operation. The rollers, #344-A, #344-B may be provided with grooves #344-C. As is included in this drawing, to receive and hold guide lines #338-A, portions of an embodiment of a filtering material #338. portion of the equipment. A drive motor #340 may be provided with a pulley or sprocket #325. connected to a an additional pulley or sprocket #326 on the primary roller #344-A by a belt or chain #327.

This drawing includes an embodiment of an upper roller #344-A. And a lower roller #344-B. Stationed laterally between and rotate-ably attached to the end portions of an embodiment of, both an inboard and an outboard ridged vertical contaminant walls. #320. By means of rollers axles extending through and mechanically fastened to same. This embodiment of an upper roller. #344-A. Is also equipped with an embodiment of a threaded tensioning rod #329. Of which this embodiment thereof, would be stationed on both sides of this embodiment of the equipment. Of which is also included in the drawings in FIG. 5, and FIG. 7. And of which was simply included to provide an effective mode to adjust the position of the upper roller portion of the equipment and thus the tension of the embodiment of the filtering material portion of the equipment, when installed on same. Of which is not included in this drawing However an embodiment of the filtering material portion of the equipment is included in FIG. 8. In this embodiment thereof. FIG. 7. Illustrates a side view of an embodiment of a portion of the basic composition of components comprising an embodiment of a primary portion of the floating contaminant cleanup equipment. #334. Of which may include a framework #339. Of which may be stationed in between the vertical side wall portions of the contaminant cleanup equipment #334. and #335. Supporting the positioning of the primary and secondary roller. As well as the vertical contaminant wall portions of the equipment (Not included in this drawing of an embodiment thereof. As well as a plurality of small rollers #342. Of which may also be provided and stationed at intervals along the top of the framework #339, facilitating additional support and ease of movement of the filtering material portions of the equipment. (also not included in this drawing. A tensioned plate or blade #352. May also be provided at an end portion of #334 and #335. as well, With embodiments of the plate or blade #352. being capable of maintaining an edge of same compressibly tensioned against the outer surface of the filtering material and the upper roller #344-A. Portions of the equipment, to remove any contaminant #109 remaining on the outer surface portions thereof. During the operation. In this embodiment thereof.

FIG. 8 illustrates a top view of a reinforced one piece filtering material portion of the equipment, with this embodiment thereof drawn as if same had been removed from the embodiment of the portions of the equipment. Such as the embodiment of the portion of the equipment included in FIG. 6, and had the end portions thereof folded over towards each other.

The filtering material #338. May be made as a single piece, with opposite ends thereof fasted to each other by means of metal fasteners or an inserted rod or pin. However, the filtering material #338. may also be made of a plurality of segments, with each segment adjoined to adjacent segments. #338. May also be made of any suitable material that allows water to pass through the cover while retaining the contaminant #109. On the surface of thereof known in the art or to be developed, including but not limited to fiber mesh material with a mesh size that is selected based on the contaminant to be removed from the body of water.

This embodiment of #338. Comprises a reinforced porous material with the porosity being of a diameter capable of allowing water to freely pass through same while also being small enough to restrict the organisms making up colonies of toxic blue green algae from passing though same. However, the filtering material #338 may be made of any suitable material that allows water to pass through the cover while retaining the contaminant #109. On the surface of the cover #338, known in the art or to be developed, including but not limited to fiber mesh material with a mesh size that is selected based on the contaminant to be removed from the body of water. The guide lines #338-A, made from a strong and non-stretchable type of line, or fibers such as Dyeema, Kevlar, or any other suitable material known in the art or to be developed. This embodiment of #338. Is constructed of a width and configured in a manner. Such that the outer side portions of. #338, would extend laterally between the inside surface portions of the two vertical containment walls, rub up against same and create a continuous seal up against the inner side portions thereof, when in service and would also extend lineally around the outer surface portions and extend between the upper and lower roller portions of the embodiments of the floating contaminant cleanup equipment and with each of the end plate portions of this embodiment of #338. simply overlapping each other and then connected to each other by means of a plurality of mechanical fasteners #338-B. In this embodiment thereof. This embodiment of the filtering material portion of the equipment also comprises a plurality of lines or fibers #338. Made out of an extremely strong and non-stretchable type of line, or fibers. Such as Dyeema. Of which is an extremely strong and non-stretchable, high modulus polyethylene type of line, or fibers. Of which are not only rated as the strongest fibers in the world, but Dyeema fibers are also very soft and playable such that the filtering material portion of the equipment it self could and fay be constructed of same. Another employable type of extremely strong and non-stretchable line, or fibers would also be Kevlar, Of which isn't quite as strong nor does Kevlar hold up to UV exposure nearly as well as high modulus polyethylene fibers. However Kevlar, like Dyeema fibers are also woven into materials for certain applications where extreme strengths and durability is required and of which can also be produced in any weave and tightness thereof to achieve porosity of a any diameter needed as well and as a result thereof either high modulus polyethylene or Kevlar may also be the fibers of choice for the actual filtering material portions of the embodiments of the equipment to be constructed of. Of which would not only provide embodiments of same with more than adequate levels of structural integrity and configurational stability in the performance of all tasks required of embodiments of the filtering material #338. Portions of the equipment. But would likely also hold up for many years without having to be replaced. Embodiments of the filtering material portions of the equipment constructed in this manner would also be employable on embodiments of the contaminant cleanup equipment equipped with just smooth or neoprene coated upper and lower rollers. Such as the embodiments thereof included in FIG. 11. and FIG. 12. With no grooves cut around the outer parameters of same. Such as the embodiment of the roller portions of the equipment. Included in FIG. 6.

However, this drawing of the filtering material portion of the equipment #338. Is drawn as if this embodiment thereof simply includes lengths of Dyeema, or another type of line #338-A. Made as an integral portion of #338. With lengths of same stationed at a distance from each other laterally and extending lineally the entire length. of this embodiment of #338. Where, both of the end portions of. #338. and #338-A. Would be secured to the end plate portions of 338. And simply connected to each other when installed on the rest of the embodiment of the equipment.

Such that when this embodiment of the filtering material. #338. Is installed on the embodiment of the contaminant cleanup equipment, with both end portions of same connected to each other and the tension is adjusted to same. Each of the lengths of line #338-A. Comprising this embodiment of. #338. Would be partially compressed into grooves. #344-C. Included in the embodiments of the upper and lower roller #344-A and #344-B. Include in FIG. 6. Of which, are spaced at the same distance laterally around the outer surface portions of the embodiment of both the upper and lower embodiments of the rollers. #344-A. and #334-B. Of which, although unnecessary would serve much like tracks for the embedded line portions of this embodiment of the filtering material. #338. To compress-ably track in during the employment of same. In this embodiment thereof.

FIG. 9 illustrates a disassembled view of the drive motor assembly comprising a drive motor #340 with an attached pulley #325, a mounting platform #343-A, a base plate #343-B, tracks #343-C, a spring housing #343-D and spring #341. The drive motor #340 may have a pulley #325 attached to it to facilitate its driving of the primary rotor #344-A via a belt #327 attaching its pulley #325 to a pulley #326 on the primary roller #344-A. The drive motor #340 may be mounted on a mounting platform #343-A having projections that may slidably engage with tracks #343-C on a base platform #343-B. a spring housing #343-D may be provided on one or both of the mounting platform #343-A to house spring #341. Spring #341 may maintain the tension on belt #327 during operation to facilitate drive motor's #340 ability to drive the primary roller #344-A.

FIG. 9. Includes a drawing of a dissembled view of an embodiment of several of the basic function enabling components, capable of rotating an embodiment of the main drive roller #344-A. Of which are also included in and viewable in the assembled views of same in. FIG. 6. FIG. 7, and FIG. 10. Beginning with an embodiment of a drive roller drive motor. #340. Mounted on an embodiment of a drive motor mounting platform #343-A. Of which this embodiment thereof would be welded or mechanically fastened to inner surface portions of the vertical walls and with this embodiment of #343-A, slide-ably connected to a base mounting plate #343-B, for drive motor. #340. By means of interlocking tracks. #343-C. Capable of slide-ably connecting #334-A. with 344-B. In this drawing of an embodiment thereof. Of which also includes a spring #341. Of which includes a portion of each end of same inserted into the open spring base housing #343-D. portions of #343-A. and #343-B. In this drawing of an embodiment thereof. Of which is also included in and will be fully understood the drawing and description of same provided for FIG. 10.

FIG. 10 illustrates a side view of a drive motor #340 on a mounting platform #343-A, the drive motor #340 having a pulley or sprocket #325 connected to the pulley or sprocket #326 of the primary roller #344-A, via a belt or chain #327, to drive same during operation o The mounting platform for drive motor #340, may be provided with a spring housing #343-D, which houses spring #341. Of which may be provided in a spring housing #343-D. To maintain adjustment of the belt or chain regardless of adjusted position of the drive roller. After adjusting the tension of the filtering material portion of the equipment. In this embodiment thereof.

FIG. 10. Includes a drawing of an assembled view of an embodiment of the basic function enabling composition of components, also included in and viewable in the assembled views of same in. FIG. 6. FIG. 7. Capable of rotating an embodiment of the main drive roller. #344-A. viewable In FIG. 6, and FIG. 11. This drawing also includes, an embodiment of a pinion. #325 and crown #326. Pulley and belt or sprockets and chain. Of which would be connected to and capable of rotating the upper or drive roller by means of an embodiment of the main drive roller motor #340. This drawing also shows the drive roller motor mounted on a drive motor mounting platform #343-A.

With same slide-ably connected to an embodiment of the base plate #343-B. As well as the same embodiment of a spring #341. Of which includes a portion of each end of same inserted into the open spring base housing #343-D. portions of #343-A. and #343-B. Such that when installed this embodiment of the base plate #343-B. Portion of same would extend between and include the outer side portions of same either welded or mechanically fastened to an embodiment of inner side portions of the two ridged vertical contaminant containment panel portions of an embodiment of the equipment. Thus, maintaining the proper tension by means of the embodiment of the spring #341. To the belt or chain, extending between the embodiment of the pinion pulley or sprocket, on the drive motor #325. and the crown pulley or sprocket, connected to the main drive roller portions of the equipment, when adjusting the tension of #338. On the embodiment of the equipment by beans of an embodiment of a threaded rod. #329. Such as included in the drawings of the embodiment thereof included in FIG. 5. through FIG. 7. Capable of adjusting the position of the upper roller portion of the equipment and thus adjust the tension of the filtering material portions of the equipment, by means of the rotational adjustment of same. In this embodiment thereof.

FIG. 11 illustrates an overhead view of the primary roller #344-A, Of which this embodiment thereof has an attached pulley or sprocket #326 Of which would enable this embodiment thereof to be connected to the primary motor #340 via a belt or chain. #327. such as the embodiment thereof included in FIG. 10. However, Persons of skill in the art will recognize that the primary roller #344-A may be located at the upper portion of the equipment, or may be disposed at any suitable location within the equipment. An embodiment of additional intermediary rollers (not shown) may also be included as portions of the equipment. These intermediary rollers may be passive or active and may, or may not possess a connection to a drive motor to drive such rollers.

FIG. 12 illustrates an overhead view of lower roller #344-B. Persons of skill in the art will recognize that the disclosed concepts may be implemented with lower roller #344-B being a passive roller as in the embodiment in FIG. 6. Or may also be an active roller driven by means a motor. In this embodiment thereof.

It will be apparent to one with skill in in the art of floating contaminant cleanup equipment, vessels and systems of the inventions may be provided using some or all of the mentioned features components and systems, without departing from the spirit and scope of the present inventions. It will also be apparent to one with skill in in the art of floating contaminant cleanup equipment, vessels and systems of the inventions that embodiment's described above are specific examples of single broader inventions, which may possess broader than any of the singular descriptions taught. There may be many alterations made in the descriptions, without departing from the spirit and scope of the inventions included in this application.

The descriptions set forth above are meant to be illustrative and not limiting. Various modifications to the disclosed embodiments, in addition to those described herein, will be apparent to those skilled in the art from the foregoing description. Such modifications are also intended to fall within the scope of the concepts described herein. The disclosures of each patent, patent application, and publication cited or described in this document are hereby incorporated herein by reference, in their entireties.

The foregoing description of possible implementations consistent with the present disclosure does not represent a comprehensive list of all such implementations or all variations of the implementations described. The description of some implementations should not be construed as an intent to exclude other implementations described. For example, artisans will understand how to implement the disclosed embodiments in many other ways, using equivalents and alternatives that do not depart from the scope of the disclosure. Moreover, unless indicated to the contrary in the preceding description, no particular component described in the implementations is essential to the invention. It is thus intended that the embodiments disclosed in the specification be considered illustrative, with a true scope and spirit of invention being indicated by the following claims.

I claim:

1. A vessel for cleaning toxic blue-green algae floating on a body of water, the vessel comprising:
a hull having two long sides;
a first cleanup and recovery equipment comprising an intake end, a second end, two vertical walls and a filtering material extending between the vertical walls;
wherein outer side portions of the filtering material press against and create a seal with a lower inner surface portion of the two vertical walls, and the filtering material also extends from the intake end to the second end of the first cleanup and recovery equipment such that when activated while the vessel is moving forward, the filtering material separates the toxic blue-green algae from the body of water as water and toxic blue-green algae from the body of water is forced upward and between the two vertical walls and over the filtering material using a water pressure resulting from the motion of the vessel and the upwardly forced water, and transports the toxic blue-green algae toward the second end of the first cleanup and recovery equipment and into the vessel.

2. The vessel for cleaning toxic blue-green algae floating on a body of water of claim 1, further comprising a first containment boom capable of being deployed from near the intake end of the first cleanup and recovery equipment, and extending forward and off to a first side of the vessel, such that when the vessel is moving forward on the body of water and has deployed the first cleanup and recovery equipment and the first containment boom, the first containment boom captures and funnels the contaminant toward the intake end of the first cleanup and recovery equipment.

3. The vessel for cleaning toxic blue-green algae floating on a body of water of claim 1, further comprising:
a second cleanup and recovery equipment comprising an intake end, a second end, two vertical walls and a filtering material extending between the vertical walls;
wherein outer side portions of the filtering material of the second cleanup and recovery equipment press against and create a seal with a lower inner surface portion of the two vertical walls of the second cleanup and recovery equipment, and the filtering material of the second cleanup and recovery equipment also extends from the intake end to the second end of the of the second cleanup and recovery equipment such that when activated while the vessel is moving forward, the filtering material of the second cleanup and recovery equipment separates the toxic blue-green algae from the body of water as water and toxic blue-green algae from the body of water is forced upward and between the two vertical walls and over the filtering material of the second cleanup and recovery equipment using a water pressure resulting from the motion of the vessel and the upwardly forced water, and transports the toxic blue-green algae toward the second end of the second cleanup and recovery equipment and into the vessel.

4. The vessel for cleaning toxic blue-green algae floating on a body of water of claim 3, further comprising a second containment boom capable of being deployed from near the intake end of the second cleanup and recovery equipment, and extending forward and off to a second side of the vessel such that when the vessel is moving forward on the body of water and has deployed the second cleanup and recovery equipment and the second containment boom, the second containment boom captures and funnels the contaminant toward the intake end of the second cleanup and recovery equipment.

5. The vessel for cleaning toxic blue-green algae floating on a body of water of claim 1, wherein the first cleanup and recovery equipment further comprises a primary roller rotatable by a drive motor such that the primary roller can move the filtering material.

6. The vessel for cleaning toxic blue-green algae floating on a body of water of claim 5, wherein the primary motor is slidably mounted on a mounting base.

7. The vessel for cleaning toxic blue-green algae floating on a body of water of claim 2, wherein a first tow boat connects to and tows the first containment.

8. The vessel for cleaning toxic blue-green algae floating on a body of water of claim 7, further comprising a boom capable of deploying and recovering the first tow boat.

9. The vessel for cleaning toxic blue-green algae floating on a body of water of claim 1, further comprising a first deployment equipment capable of deploying the first cleanup and recovery equipment from a stored position to an operating position.

10. The vessel for cleaning toxic blue-green algae floating on a body of water of claim 9 wherein the first deployment equipment comprises a winch.

11. The vessel for cleaning toxic blue-green algae floating on a body of water of claim 1, further comprising a tank capable of storing the toxic blue-green algae removed from the body of water.

12. The vessel for cleaning toxic blue-green algae floating on a body of water of claim 2, further comprising first armature capable of deploying the first containment boom.

13. The vessel for cleaning toxic blue-green algae floating on a body of water of claim 12, wherein the first armature comprises a telescoping crane.

14. Contaminant cleanup and recovery equipment for removing toxic blue-green algae from a body of water comprising:
an intake end;
a second end;
two vertical walls; and
a filtering material extending between the vertical walls;
wherein outer side portions of the filtering material press against and create a seal with a lower inner surface portion of the two vertical walls, and the filtering material also extends from the intake end to the second end of the first cleanup and recovery equipment such that when activated while the vessel is moving forward, the filtering material separates the toxic blue-green algae from the body of water as water and toxic blue-green algae from the body of water is forced upward and between the two vertical walls and over the filtering material using a water pressure resulting from the motion of the vessel and the upwardly forced water, and transports the toxic blue-green algae toward the second end of the first cleanup and recovery equipment and into the vessel.

15. The contaminant cleanup and recovery equipment for removing toxic blue-green algae from a body of water of claim 14, further comprising a pivotable attachment capable of connecting to the hull of a vessel.

16. The contaminant cleanup and recovery equipment for removing toxic blue-green algae from a body of water of claim 14, further comprising:
a first containment boom capable of being deployed from near the intake end of the first cleanup and recovery equipment, and extending forward and off to a first side of the first cleanup and recovery equipment such that when equipped and deployed on a vessel that is moving forward on the body of water the first containment boom captures and funnels the contaminant toward the intake end.

17. The contaminant cleanup and recovery equipment for removing toxic blue green algae from a body of water of claim 14, further comprises a primary roller rotatable by a drive motor such that the primary roller can move the filtering material.

18. The contaminant cleanup and recovery equipment for removing toxic blue green algae from a body of water of claim 17, wherein the primary motor is slidably mounted on a mounting base.

19. A floating biological contaminant cleanup and recovery equipment mountable on an outer freeboard portion of a vessel on a body of water containing a biological contaminant, the equipment comprising:
a forward intake end capable of being disposed within the body of water;
a second end capable of being disposed above the forward intake end;
a filtering material extending there between capable of allowing water to from the body of water to freely pass through the filtering material while restricting biological contaminants from passing through; and
a first and second vertical wall extending vertically upward, and comprising lower inner surface portions;
wherein the filtering material comprises outer side portions that create a slidable seal against the lower inner surface portions of the first and second vertical walls, creating a containment area there-between same, such that
when activated while the vessel is moving forward, the filtering material separates the biological contaminant from the body of water as water and biological contaminant from the body of water is forced upward and between the first and second vertical walls and over the filtering material using a water pressure resulting from the motion of the vessel and the upwardly forced water, and transports the biological contaminant toward the second end.

20. The floating biological contaminant cleanup and recovery equipment of claim 19, wherein the biological contaminant comprises toxic blue-green algae.
